(19) United States
(12) Patent Application Publication
(10) Pub. No.: US 2016/0335064 A1
(43) Pub. Date: Nov. 17, 2016

(54) INFRASTRUCTURE TO SUPPORT ACCELERATOR COMPUTATION MODELS FOR ACTIVE STORAGE

(71) Applicant: Advanced Micro Devices, Inc., Sunnyvale, CA (US)

(72) Inventors: Shuai Che, Bellevue, WA (US); Sudhanva Gurumurthi, Boxborough, MA (US); Michael W. Boyer, Bellevue, WA (US)

(73) Assignee: Advanced Micro Devices, Inc., Sunnyvale, CA (US)

(21) Appl. No.: 14/709,915

(22) Filed: May 12, 2015

(51) Int. Cl. G06F 9/45; G06F 9/44

(52) U.S. Cl. CPC G06F 8/447; G06F 8/30

(57) ABSTRACT

A method, a system, and a non-transitory computer readable medium for generating application code to be executed on an active storage device are presented. The parts of an application that can be executed on the active storage device are determined. The parts of the application that will not be executed on the active storage device are converted into code to be executed on a host device. The parts of the application that will be executed on the active storage device are converted into code of an instruction set architecture of a processor in the active storage device.

### TECHNICAL FIELD

The disclosed embodiments are generally directed to active storage devices, and in particular, to a system architecture and a software stack to implement an active storage device.

### BACKGROUND

The recent development of “big data” has resulted in massive amounts of data generated for processing. Many data-intensive and input/output (I/O)-intensive workloads can leverage “active storage,” which offloads computation to a processor integrated in a storage device. This is beneficial because I/O and memory bandwidths are improving at a slower pace than on-chip computation resources. With active storage, instead of moving data from the storage device into memory for computation, the processing is moved into the storage device (disk drives, solid-state drives (SSDs), or other storage devices), thereby reducing the amount of data moved to improve performance and reduce energy consumption.

Active storage has been studied extensively. Recent research has evaluated integrating a graphics processing unit (GPU) in a SSD and has discussed specific programming styles (e.g., MapReduce and disklet) for active storage offload. Active storage has typically been implemented in firmware or in storage hardware. But the firmware implementation is limiting, because the basic logic is not flexible enough to permit programmers to write different types of applications for the active storage device.

### SUMMARY OF EMBODIMENTS

Some embodiments provide a method for generating application code to be executed on an active storage device. The parts of an application that can be executed on the active storage device are determined. The parts of the application that will not be executed on the active storage device are converted into code to be executed on a host device. The parts of the application that will be executed on the active storage device are converted into code of an instruction set architecture of a processor in the active storage device.

Some embodiments provide a system for generating application code to be executed on an active storage device. A host includes a first processor that is configured to determine which parts of an application can be executed on the active storage device, convert parts of the application that will not be executed on the active storage device into code to be executed on a host device, and convert parts of the application that will be executed on the active storage device into code of an instruction set architecture of a processor in the active storage device. The active storage device includes a second processor configured to execute parts of the application.

Some embodiments provide a non-transitory computer-readable storage medium storing a set of instructions for execution by a general purpose computer to generate application code to be executed on an active storage device. The set of instructions includes a determining code segment, a first converting code segment, and a second converting code segment. The determining code segment determines which parts of an application can be executed on the active storage device. The first converting code segment converts parts of the application that will not be executed on the active storage device into code to be executed on a host device. The second converting code segment converts parts of the application that will be executed on the active storage device into code of an instruction set architecture of a processor in the active storage device.

### BRIEF DESCRIPTION OF THE DRAWINGS

A more detailed understanding may be had from the following description, given by way of example in conjunction with the accompanying drawings, wherein:

FIG. 1 is a block diagram of an example device in which one or more disclosed embodiments may be implemented;

FIG. 2 is a block diagram of one embodiment of a system architecture in a solid-state drive implementing active storage;

FIG. 3 is a block diagram of a software stack for use in implementing active storage;

FIG. 4 is a flowchart of a method for compiling code to be executed at least partially on an active storage device; and

FIG. 5 is a flow diagram of a system configured to compile code to be executed at least partially on an active storage device.

### DETAILED DESCRIPTION

A method, a system, and a non-transitory computer readable medium for generating application code to be executed on an active storage device are presented. The parts of an application that can be executed on the active storage device are determined. The parts of the application that will not be executed on the active storage device are converted into code to be executed on a host device. The parts of the application that will be executed on the active storage device are converted into code of an instruction set architecture of a processor in the active storage device.

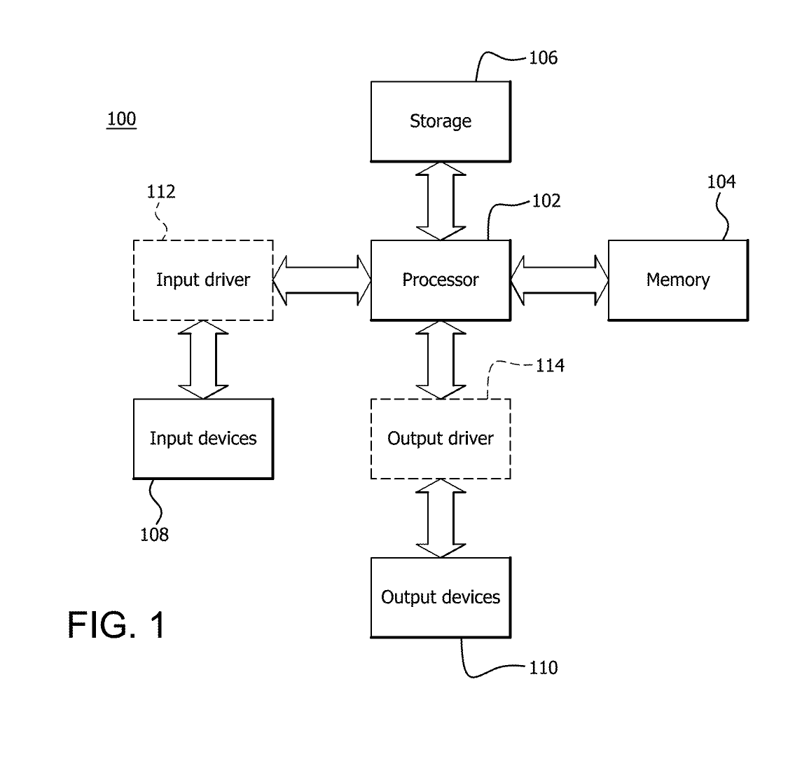

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

An architecture and software stack are described for programming, compiling, and running applications on active storage devices to offload the computation to the active storage device through runtime compilation. The framework described herein also proposes mechanisms to support accelerator programming models and portable codes for active storage devices and associated software infrastructure to enable computation offload.

A programmer may write any type of application for the active storage device. An intermediate language runtime provides the application programming interface (API) to access the active storage device. The intermediate language is used for portability and flexible code optimization. The active storage device implements the runtime, which is responsible for job scheduling and resource management for the active storage device. Both the intermediate language and the intermediate language runtime serve layers between the high-level language (and corresponding high-level language runtime) and the underlying active storage device.

Traditionally, the operating system (OS) file system interacts with the device driver for file-block reads and writes. In the case of a flash drive, the flash translation layer works with the OS to make the flash memory appear to the system like a block-based disk drive. The framework also presents the roles and functionality of device drivers to support and manage the compute and memory resources on the active storage device.

The following description uses a flash-based SSD as an example active storage device, but the ideas also apply to other types of storage devices. As used in the following description, the term “active storage device” includes an SSD and any other type of storage device where a processor may be installed to implement an active storage device.

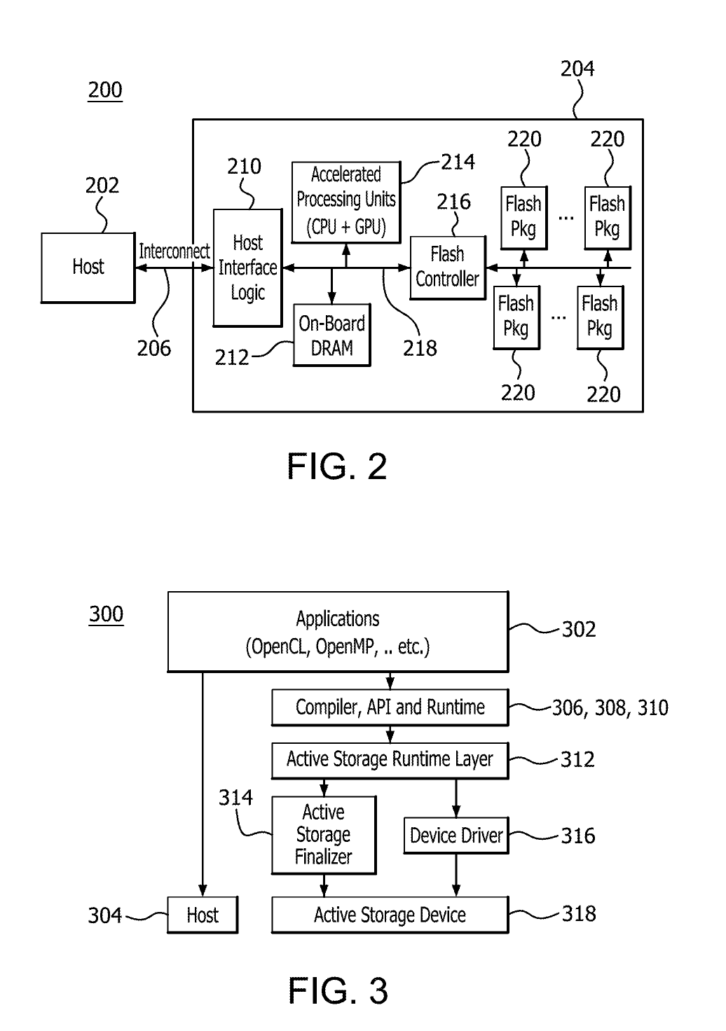

FIG. 2 is a block diagram of one embodiment of a system architecture 200 implementing active storage. The system 200 includes a host 202 and an active storage device 204, which is shown in FIG. 2 as an SSD. The host 202 and the active storage device 204 are connected via an interconnect 206. The active storage device 204 includes a host interface logic 210, an on-board dynamic random access memory (DRAM) 212, an accelerated processing unit (APU) 214, and a flash controller 216 communicating over a bus 218. The flash controller 216 manages a plurality of flash packages 220.

The host interface logic 210 manages communications with the host 202 via the interconnect 206, which may be any type of interconnect, including, but not limited to, Serial AT Attachment (SATA), Peripheral Component Interconnect Express (PCI-E), Non-Volatile Memory Express (NVMe) or Universal Serial Bus (USB). The DRAM 212 buffers requests, data, and intermediate computation results. The APU 214 may include multiple central processing unit (CPU) cores and multiple GPU compute units. The APU 214 has two major roles: (1) device control and management, such as managing flows for file requests and mapping between OS disk logic blocks and physical blocks on the flash packages 220; and (2) executing offloaded computations from the host 202. The flash controller 216 handles requests and data transfers along the connections to the flash packages 220.

FIG. 3 is a block diagram of a software stack 300 for use in implementing active storage to enable computation offloading. Any software architecture may be used to implement the software stack 300, including, but not limited to, the Heterogeneous System Architecture. Regardless of the software architecture used, the software stack 300 would have a similar construction and would operate in a similar manner.

The software stack 300 includes an application 302 that communicates with a host 304 and with a compiler, API, and runtime 306, 308, 310. The compiler, API, and runtime 306, 308, 310 communicate with an active storage runtime layer 312, which in turn communicates with an active storage finalizer 314 and a device driver 316. The finalizer 314 and the device driver 316 communicate with an active storage device 318.

The actual implementation and packaging of the software components may vary, but other possible instantiations of the software stack 300 will have similar functionality. An application 302 written in an accelerator programming model (e.g., OpenCL™, OpenMP®, OpenACC, etc.) goes through a sequence of steps to run on the active storage device 318. For example, in OpenCL™, programmers write a kernel to specify the computation to execute on the active storage device 318. The code will also manage buffers for the active storage device memory, schedule kernel launches, and handle host-storage communications. The compiler 306 can detect what part of the code can be offloaded, similar to how GPU computations are offloaded by determining what hardware is present. In OpenMP® and OpenACC, programmers label a particular application section for offloading with pragmas. Regardless of the original programming model used, the application 302 is compiled into host code, and API calls are converted to the language-specific runtime library and kernel code.

The language-specific runtime 310 communicates with the runtime layer 312 to dispatch the work to the active storage device 318 via the device driver 316. The computation kernel code (either an OpenCL™ kernel or the offloaded part labeled by a programmer) is translated into an intermediate language representation. When dispatching the work to the active storage device 318, the kernel code is translated to a device-specific instruction set architecture (ISA) for the processor on the active storage device 318. The runtime layer 312 interfaces with the device driver 316, which manages the active storage device 318 hardware resources (e.g., memory allocation and deallocation) and schedules computation (e.g., queuing jobs on the active storage device).

In one example, OpenCL™ has its own API to manage buffers, launch threads, etc. The OpenCL™ code needs to be mapped to the runtime layer 312, which has “universal” designations how to manage buffers, launch threads, etc. The computation kernel is compiled into an intermediate instruction set. The finalizer 314 translates the intermediate code into code to be run on the active storage device 318. The runtime layer 312 interacts with the active storage device 318 via the device driver 316 to perform the actual buffer allocation, etc.

The following pseudo-code describes the typical application flow for an active storage offload:

```
  create_buffer(void* ptr_d, size); //create a memory buffer on
active storage device
  file read(ptr_d, size, file); //read a file into the buffer
  ...
  launch(kernel); //launch the computation on active storage device
  ...
  file_write(ptr_d, size, file); //directly write back the results
  memcpy(ptr_h, ptr_d, size); //copy the results from the active
storage device memory buffer to another buffer
```

This pseudo-code first allocates a memory buffer in the active storage device's DRAM, and then reads a file into the memory buffer. With an SSD, this is achieved by loading data (blocks/pages) from the flash packages to the SSD DRAM (the SSD maps the logical blocks specified by the OS to the physical flash locations). Subsequently, the computation kernel is launched on the integrated APU in the active storage device. After the kernel completes, the results are written back to the active storage device storage directly or may be used for other purposes (e.g., subsequent computation on the host or other devices by transferring data to the host memory). For files larger than the active storage device buffer size, the computation can be partitioned and scheduled in chunks.

The active storage device memory model may use either unified or disjoint memory spaces. For instance, to support OpenCL™, different embodiments can treat the global memory space as the combined active storage device and host memory, or only the active storage device memory itself (with the host memory treated as a separate memory space).

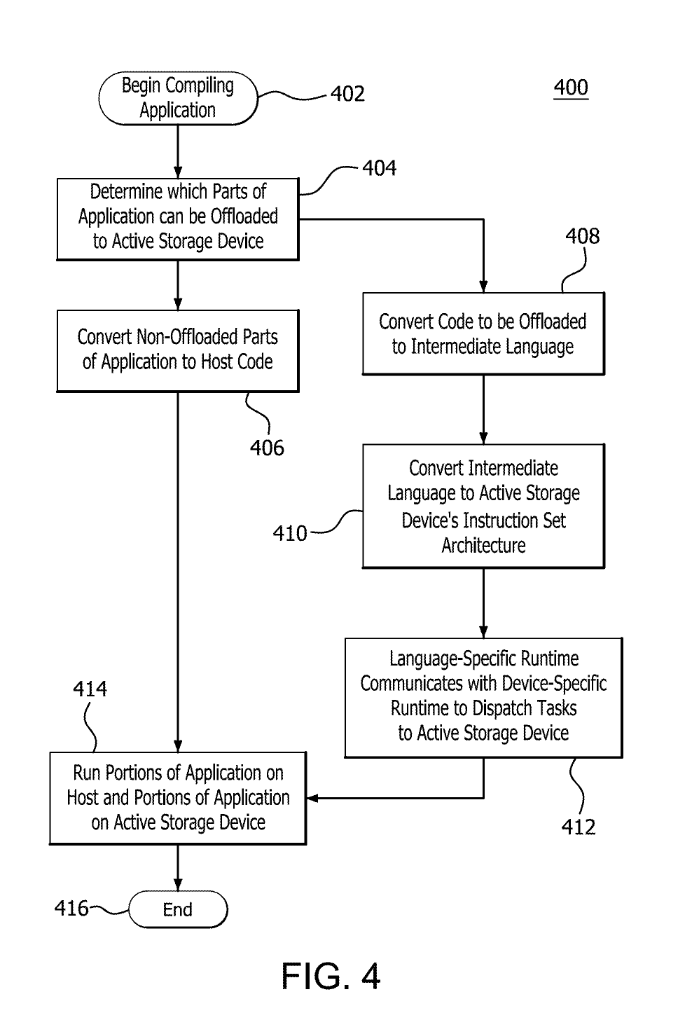

FIG. 4 is a flowchart of a method 400 for compiling code to be executed at least partially on an active storage device. An application begins being compiled (step 402) and a determination is made which parts of the application can be offloaded to the active storage device for execution (step 404). This determination may be made via hints or directives in the application code itself or via an evaluation of the code by the compiler. The evaluation may include determining what hardware is available (e.g., the capabilities of the processor on the active storage device), an amount of data needed to perform the computations, and/or an intensiveness of data accesses (e.g., high data access versus compute ratio) in the code to be offloaded. For example, if the amount of data and/or the intensiveness of data accesses exceed a predetermined threshold (there may be different thresholds for each of these criteria), then the computation will be offloaded to the active storage device, to reduce the amount of data traffic in the system. Other considerations may also be relevant to this determination. For example, there may be security considerations that may warrant processing some data within the active storage device rather than moving data outside the active storage device and potentially exposing the data during the transfer between the active storage device and the host. Another consideration may include evaluating an energy efficiency metric for the cost of data movement between the active storage device and the host.

The non-offloaded parts of the application are converted into host code (step 406). The parts of the application that are to be offloaded to the active storage device are converted into an intermediate language representation (step 408). The intermediate language representation is converted into the instruction set architecture of the active storage device (step 410). A language-specific runtime component communicates with a device-specific runtime component to dispatch tasks to the active storage device (step 412). The portions of the application that can run on the host are executed, along with the portions of the application to be executed on the active storage device (step 414) and the method terminates (step 416). It is noted that steps 406 and 408-412 may be run concurrently with each other without altering the overall operation of the method 400.

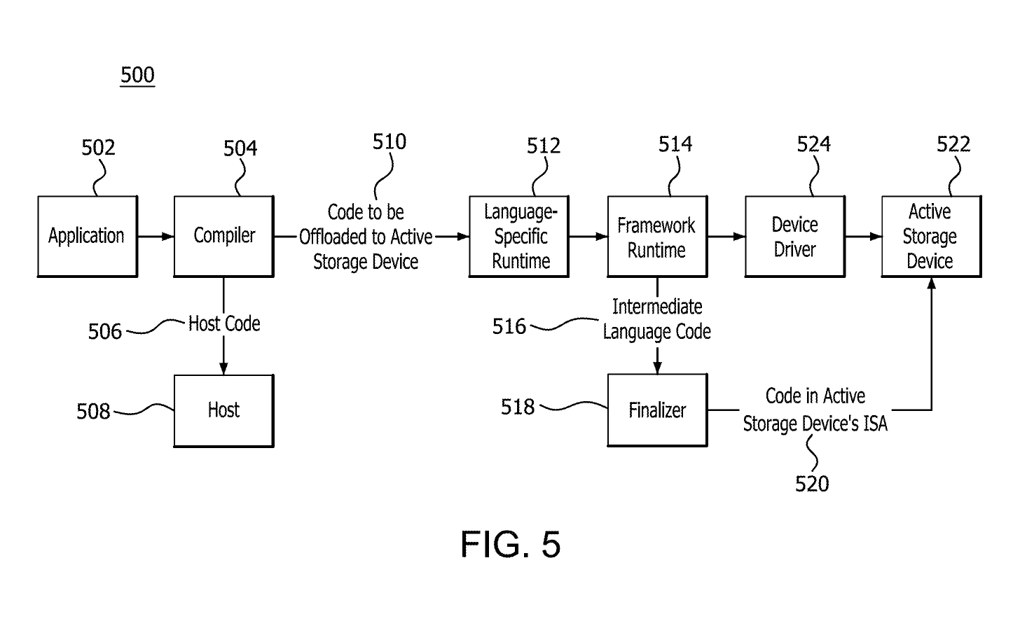

FIG. 5 is a flow diagram of a system 500 configured to compile code to be executed at least partially on an active storage device. An application 502 is provided to a compiler 504 for compilation. The compiler 504 generates host code 506 for a portion of the application to be executed on a host 508. The compiler 504 also determines a portion of code 510 to be offloaded to an active storage device. The portion of code 510 is provided to a language-specific runtime 512 which communicates with a framework runtime 514. The framework runtime 514 generates an intermediate language code 516 for the portion of code 510. The intermediate language code 516 is provided to a finalizer 518 which generates code 520 in the active storage device's instruction set architecture. The code 520 may then be executed on an active storage device 522. The language-specific runtime 512 works with the framework runtime 514 to dispatch work items to the active storage device 522 via a device driver 524.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for generating application code to be executed on an active storage device, the method comprising:
converting parts of the application that will not be executed on the active storage device into code to be executed on a host device; and
converting parts of the application that will be executed on the active storage device into code of an instruction set architecture of a processor in the active storage device.

2. The method of claim 1, further comprising:
determining which parts of an application can be executed on the active storage device.

3. The method of claim 1, wherein the determining is based on hints or directives included in the application.

4. The method of claim 1, wherein the determining is based on any one or more of:
if a compiler evaluating the application determines that an amount of data needed to perform computations in the part of the application exceeds a first predetermined threshold;
if the compiler determines that an intensiveness of data accesses in the part of the application exceeds a second predetermined threshold, wherein the intensiveness of data accesses is based on a number of data accesses versus a compute ratio; or
security of data to be processed in the part of the application.

5. The method of claim 1, wherein the converting parts of the application that will be executed on the active storage device includes:
converting the parts of the application that will be executed on the active storage device into an intermediate language; and
converting the intermediate language into the instruction set architecture of the processor in the active storage device.

6. The method of claim 1, further comprising:
executing parts of the application on the host device; and
executing parts of the application on the active storage device.

7. A system for generating application code to be executed on an active storage device, comprising:
a host including a first processor, the first processor configured to:
convert parts of the application that will not be executed on the active storage device into code to be executed on a host device; and
convert parts of the application that will be executed on the active storage device into code of an instruction set architecture of a processor in the active storage device; and
the active storage device includes a second processor, the second processor configured to execute parts of the application.

8. The system of claim 7, wherein the first processor is further configured to determine which parts of an application can be executed on the active storage device.

9. The system of claim 7, wherein the host further includes a compiler that runs on the first processor, the compiler performing the determining, the converting parts of the application that will not be executed on the active storage device, and the converting parts of the application that will be executed on the active storage device.

10. The system of claim 8, wherein the compiler is further configured to base the determining on hints or directives included in the application.

11. The system of claim 8, wherein determining which parts of the application that can be executed on the active storage device is based on any one or more of:
if the compiler evaluating the application code determines that an amount of data needed to perform computations in the part of the application exceeds a first predetermined threshold;
if the compiler determines that an intensiveness of data accesses in the part of the application exceeds a second predetermined threshold, wherein the intensiveness of data accesses is based on a number of data accesses versus a compute ratio; or
security of data to be processed in the part of the application.

12. The system of claim 7, wherein the converting parts of the application that will be executed on the active storage device includes:
converting the parts of the application that will be executed on the active storage device into an intermediate language; and
converting the intermediate language into the instruction set architecture of the processor in the active storage device.

13. The system of claim 7, wherein the second processor is an accelerated processing unit.

14. The system of claim 7, wherein the active storage device is a solid-state drive including non-volatile memory.

15. A non-transitory computer-readable storage medium storing a set of instructions for execution by a general purpose computer to generate application code to be executed on an active storage device, the set of instructions comprising:
a determining code segment for determining which parts of an application can be executed on the active storage device;
a first converting code segment for converting parts of the application that will not be executed on the active storage device into code to be executed on a host device; and
a second converting code segment for converting parts of the application that will be executed on the active storage device into code of an instruction set architecture of a processor in the active storage device.

16. The non-transitory computer-readable storage medium according to claim 15, wherein the determining code segment includes using hints or directives included in the application.

17. The non-transitory computer-readable storage medium according to claim 15, wherein the determining code segment includes determining the parts of the application that can be executed on the active storage device is based on any one or more of:
if an evaluation of the application determines that an amount of data needed to perform computations in the part of the application exceeds a first predetermined threshold;
if an intensiveness of data accesses in the part of the application exceeds a second predetermined threshold, wherein the intensiveness of data accesses is based on a number of data accesses versus a compute ratio; or
security of data to be processed in the part of the application.

18. The non-transitory computer-readable storage medium according to claim 15, wherein the second converting code segment includes:
a third converting code segment for converting the parts of the application that will be executed on the active storage device into an intermediate language; and
a fourth converting code segment for converting the intermediate language into the instruction set architecture of the processor in the active storage device.

19. The non-transitory computer-readable storage medium according to claim 15, wherein the instructions are hardware description language (HDL) instructions used for the manufacture of a device.
